(19) United States
(12) Patent Application Publication
(10) Pub. No.: US 2025/0095319 A1
(43) Pub. Date: Mar. 20, 2025

(54) Two-Stage Suppression for Multi-Class, Multi-Object Detection and Tracking Systems

(71) Applicant: Microsoft Technology Licensing, LLC, Redmond, WA (US)

(72) Inventors: Shay AMRAM, Raanana (IL); Moti KADOSH, Raanana (IL); Yonit HOFFMAN, Herzliya (IL); Zvi FIGOV, Modiin (IL)

(73) Assignee: Microsoft Technology Licensing, LLC, Redmond, WA (US)

(21) Appl. No.: 18/602,904

(22) Filed: Mar. 12, 2024

Related U.S. Application Data
(60) Provisional application No. 63/582,868, filed on Sep. 15, 2023.

(51) Int. Cl. G06V 10/25; G06T 7/62; G06T 7/70; G06V 10/764

(52) U.S. Cl. CPC G06V 10/25; G06T 7/62; G06T 7/70; G06V 10/764

(57) ABSTRACT

The technology relates to methods and systems for performing two-stage suppression of bounding boxes generated during object detection techniques for digital images. The two-stage suppression includes a per-class suppression stage and a class-agnostic suppression stage. In an example method, preliminary bounding boxes are generated for multiple objects in a digital image. A first subset of bounding boxes is selected by performing a per-class suppression of the preliminary bounding boxes. A second subset of bounding boxes is selected by performing a class-agnostic suppression of the first subset of bounding boxes. Based on the second subset of bounding boxes, at least one of an enriched image or a video index is generated.

### CROSS-REFERENCE TO RELATED APPLICATIONS

This application claims the benefit of U.S. Provisional Application No. 63/582,868 filed Sep. 15, 2023, entitled “Two-Stage Suppression for Multi-Class, Multi-Object Detection and Tracking System,” which is incorporated herein by reference in its entirety.

### BACKGROUND

Object detection for digital images can be used to gain insights about content in images and/or a video sequence. For example, an object tracking tool can be used to detect and/or track objects throughout a video sequence. Object detection can be performed on the digital images to detect a variety of different objects, such as people, cars, furniture, and other types of objects. The results of object detection can be used for multiple different purposes, such as building an index for a video sequence, creating links to appearances of objects in a video sequence, or listing objects in images such as in a photo album.

### SUMMARY

In object-detection algorithms, multiple bounding boxes may be generated for objects detected in an image. Many of these bounding boxes may be duplicative of one another and therefore need to be suppressed. The technology disclosed herein divides the suppression of bounding boxes into two stages. The first stage is a per-class suppression of bounding boxes. The second stage is a class-agnostic suppression of bounding boxes. The combined effect of performing the two suppression stages is a better separation of overlapping classes that avoids the pitfalls and disadvantages discussed herein. The two-stage suppression helps solve the blocking effect that one class can pose over another class where object from different classes are blocking or overlapping one another in an image. This is particularly problematic for classes that are typically overlapping, such as various types of furniture, wearables, etc. The two-stage suppression also provides a computationally efficient algorithm that improves the runtime as compared to other suppression algorithms and systems.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a two-stage suppression system according to an example.

FIG. 2 depicts example images before and after suppression has been performed.

FIG. 3 depicts an example of performing an intersection-over-union calculation.

FIG. 4 depicts example images before and after per-class suppression.

FIG. 5 depicts example images before and after class-agnostic suppression.

FIG. 6 depicts an example method for performing two-stage suppression of bounding boxes.

FIG. 7 depicts an example method for performing per-class suppression of bounding boxes.

FIG. 8 depicts an example method for performing class-agnostic suppression of bounding boxes.

FIG. 9 depicts a block diagram illustrating example physical components of a computing device with which aspects of the disclosure may be practiced.

### DETAILED DESCRIPTION

As briefly discussed above, object detection systems for detecting objects in digital images provide useful information about the images. The objects that can be detected within the images may be from a variety of different classes for which the object detection systems have been trained. For example, a convolutional neural network (CNN) may be trained to identify multiple different types of objects belonging to different classes (e.g., person, chair, table).

When the object detection algorithms are performed on an image, bounding boxes are generated for the objects that are initially detected by the object detection algorithms. The bounding boxes indicate the class of the object that is detected and the region of the image for which the object is located. The object detection algorithms often produces multiple bounding boxes for a single object within the image. Where there are multiple objects within the image, multiple bounding boxes are often generated for each of the objects that are detected within the images. Having multiple, likely duplicate bounding boxes within the image creates extensive clutter and potentially duplicate results for the same object.

To reduce the clutter of the essentially duplicate bounding boxes, detection algorithms use suppression algorithms to deduplicate the bounding boxes. One example suppression algorithm that may be used is referred to as Non-Maximum Suppression (NMS). NMS compares confidence scores of the initial proposed bounding boxes and eliminates ones that overlap significantly with a bounding box having a higher confidence score. The NMS process suppresses detections that are essentially the same object. Current NMS algorithms are performed with no regard to the different classes of the bounding boxes. Instead, the current NMS algorithms analyze only the region indicated by the bounding boxes. Performing suppression without considering class has the disadvantage that detection of close or partially overlapping objects of different classes may be completed eliminated by the suppression algorithm.

This disadvantage can be observed for many different types of images. One example is where a person is one type/class of detected object and other types/classes of objects (e.g., wearables, chair, sofa) are also present in the image. In such images, the person is often overlapping with the other types of objects (e.g., a bag being carried by the person, the person sitting on a chair). In suppression systems that do not consider class of the bounding boxes, only the person or the other object is ultimately detected—but not both—despite two different, distinct objects being depicted in the image.

Among other things, the technology disclosed herein addresses this issue by efficiently dividing the suppression into two stages. The first stage is a per-class suppression of bounding boxes. The second stage is a class-agnostic suppression of bounding boxes. The combined effect of performing the two suppression stages is a better separation of overlapping classes that avoids at least the disadvantages discussed above, such as unintended suppression of a legitimate detection. The two-stage suppression helps solve the blocking effect that one class of object can pose over another class of object where objects from different classes are overlapping one another in an image. The two-stage suppression also provides a computationally efficient algorithm that improves the runtime as compared to other suppression algorithms and systems.

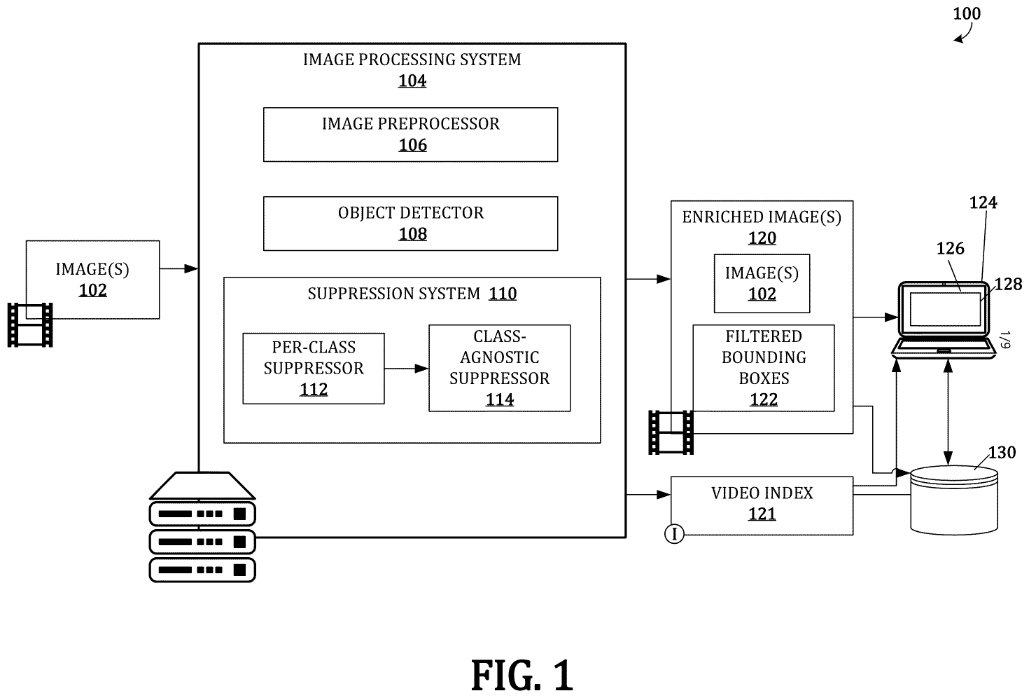

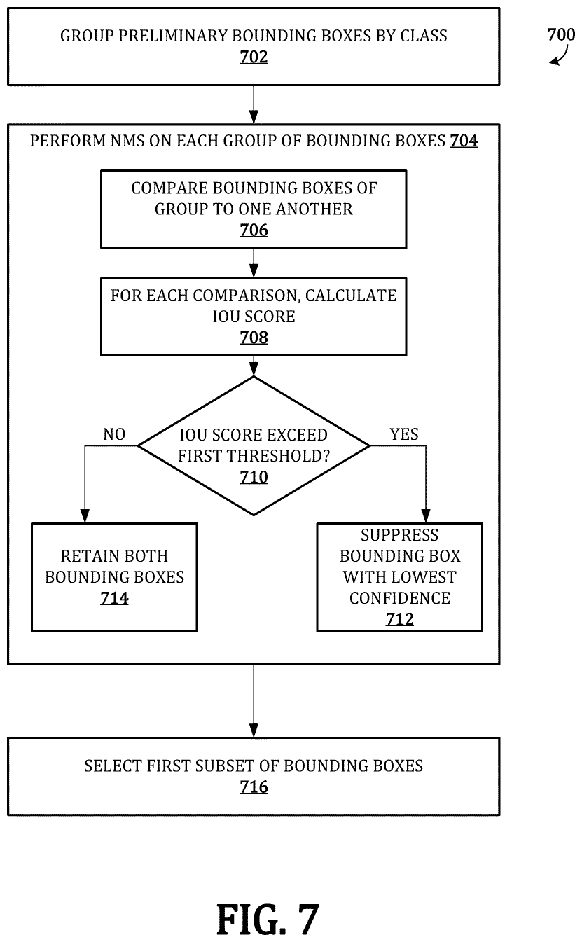

FIG. 1 is a block diagram of a two-stage suppression system 100 according to an example. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices. In one example, components of systems disclosed herein are implemented on a single processing device. The processing device may provide an operating environment for software components to execute and utilize resources or facilities of such a system. An example of processing device(s) comprising such an operating environment is depicted in FIG. 7. In another example, the components of systems disclosed herein are distributed across multiple processing devices. For instance, input may be entered on a user device or client device and information may be processed on or accessed from other devices in a network, such as one or more remote cloud devices or web-based server devices.

The example system 100 includes an image processing system 104. In some examples, the image processing system 104 is in the form a cloud-based server or other device that processes image-processing operations, such as object detection processes. In other examples, the image processing system 104 is implemented in a local or client device.

The image processing receives one or more images 102 that are to be processed by the image processing system 104. The images 102 may be received in different forms and/or formats. In some examples, the images 102 are received as video data. For instance, the video data is made of multiple frames that each constitute individual images 102.

In the example depicted, the image processing system 104 includes an image preprocessor 106, an object detector 108, and a suppression system 110. The suppression system includes a per-class suppressor 112 and a class-agnostic suppressor 114. The image preprocessor 106, object detector 108, per-class suppressor 112, and/or the class-agnostic suppressor 114 may be implemented as different algorithms, functions, and/or models in the form of a combination of software, firmware, and/or hardware. For instance, each of the image preprocessor 106, object detector 108, per-class suppressor 112, and/or the class-agnostic suppressor 114 may be associated with different portions of executable code and/or instructions stored in memory of the image processing system 104 that, when executed by one or more processors of the image processing system 104, cause the corresponding operations to be performed.

When the image processing system 104 receives the images 102, in some examples, the image preprocessor 106 first preprocesses the images 102 to format the images 102 into a format that is suitable for the object detector 108 to detect objects present in the images 102. In some examples, the images 102 are preprocessed to change the color formatting of the images 102, such as a red-green-blue (RGB) or blue-green-red (BGR) color scheme. The preprocessor 106 may also or alternatively change the aspect ratio of the images or other changes to the images 102.

The object detector 108 then detects objects within the images 102. The object detector 108 detects objects within the images 102, in part, by creating bounding boxes for the objects that are detected in the images 102. Some example object detection techniques include the use of a neural network, such as a convolutional neural network (CNN). For instance, an R-CNN (Regions with CNN Features) may be implemented. R-CNN may also be implemented with a Region Proposal Network, such as in the Faster R-CNN algorithm. Other types of object-detection techniques or models are also possible and may be implemented herein. For example, a YOLO (you only look once) real-time object detection system may be implemented. In some examples, the object detector 108 may implement processes that extract features from the from the image. Region proposals may then be generated, and the proposed regions may be provided as input into a classifier that determines if an object exists in the region and what that object may be. This process may result in the generation of bounding box having a class along with a size and position that surrounds the detected object.

The bounding boxes indicate the class of the object detected and the region of the image for which the detected object is positioned. The bounding boxes also have a confidence score. The confidence score indicates how sure or confident the detection model is that the bounding box contains the object. For example, the confidence score indicates how confident the detection model is that the region is correct and/or how confident the detection model is that the class is correct. Accordingly, each of the bounding boxes may have a size, a location, a class, and a confidence score.

Multiple bounding boxes may be generated for a single physical object present in a particular image 102. In such examples, where there are multiple objects within an image 102 that are detected by the object detector 108, multiple bounding boxes are generated for each of the detected objects. These initial, potentially duplicative bounding boxes may be referred to herein as proposed or preliminary bounding boxes.

The suppression system 110 analyzes the preliminary bounding boxes to efficiently de-duplicate the preliminary bounding boxes using a two-stage suppression process. The first stage of the suppression process is a per-class suppression process and is performed by the per-class suppressor 112. The second stage of the suppression process is a class-agnostic suppression process that is performed by the class-agnostic suppressor 114.

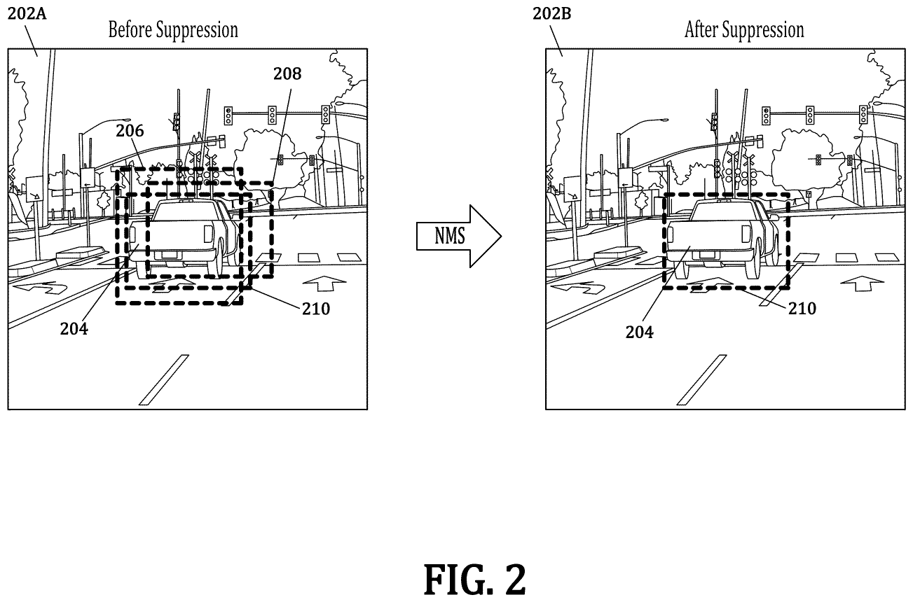

The per-class suppressor 112 performs the per-class suppression by analyzing the preliminary bounding boxes according to their classes and deduplicating the preliminary bounding boxes. For instance, the preliminary bounding boxes belonging to a first class are analyzed together, and the preliminary bounding boxes of a second class are analyzed together. Bounding boxes belonging to additional different classes are similarly analyzed by class. As an example, NMS is performed against the bounding boxes of each class to de-duplicate the preliminary bounding boxes generated for the image 102. Additional details of the NMS suppression process are discussed further below with respect to FIGS. 2-8. The per-class suppressor 112 selects a first subset of preliminary bounding boxes for each class of objects detected in the image 102.

The class-agnostic suppressor 114 receives the first subset of preliminary bounding boxes and performs a class-agnostic suppression process on the first subset of preliminary bounding boxes to further deduplicate the bounding boxes. The class-agnostic suppression process may include performing NMS on the first subset of preliminary bounding boxes. This second stage NMS process, however, does not consider the different classes of the preliminary bounding boxes. The class-agnostic suppressor 114 outputs a second subset of preliminary bounding boxes. The second subset of preliminary bounding boxes may be considered the final or filtered set of bounding boxes for the particular image 102.

Based on the final set of bounding boxes created by the suppression system 110, the image processing system 104 generates enriched images 120. The enriched images 120 are formed from the images 102 that were initially received from the image processing system 104 (and preprocessed by the image preprocessor 106 in some examples) and the filtered bounding boxes. The filtered bounding boxes correspond to detected objects within the images 102. The enriched images 120 may be in the form of enriched video data that includes the filtered bounding boxes 122.

In some examples, the image processing system 104 also, or alternatively, generates a video index 121 based on the on the filtered bounding boxes 122. The video index 121 provides a catalog of the object data detected in the images 102 of the video data. In examples, the video index 121 provides a record of frames (e.g., images 102) of the video feed that include particular objects belonging to the different classes. The video index 121 may then be searched, analyzed, or otherwise further processed to identify or generate insights about the video data.

The enriched images 120 and/or the video index 121 may then be transmitted to at least one of a client device 124 and/or a storage 130. The client device 124 stores, processes, and/or displays the enriched images 120. In examples, the client device 124 includes a display 126 that allows for the enriched images 120 to be displayed in a user interface 128 of an application executing on the display 126. The storage 130 may be a database or other type of storage that is accessible to one or more computing devices. In an example, the storage 130 is cloud storage that is part of one or more cloud servers, which may be the same servers that host or form the image processing system 104. In other examples, the storage 130 is local storage, such as an on-premise installation or computing system. The client device 124 may be in communication with the storage 130 and have access to the data stored in the storage 130.

In some examples, the enriched images 120 are transmitted together with the video index 121. For instance, the video index 121 may be provided as metadata for the enriched images 120 and/or as a supplement to the metadata of the enriched images 120.

As should be appreciated, the improved object detection technology described herein may improve the applicability and usefulness of image and/or video data in multiple industries. For example, security and surveillance applications may be improved by more accurately and consistently detecting objects within security videos. Inventory tracking in retail environments may similarly be improved. Augmented reality applications may also benefit from the improved object detection technology disclosed herein. Medical imaging may also be more accurately processed and the objects therein (e.g., tumors, fractures, or other anomalies) may be more accurately detected. For instance, in each of these applications, the accurate detection of multiple objects of different classes is particularly useful, and those objects are often overlapping. With the technology described herein, overlapping of objects of different classes can be accurately detected without suppressing legitimate detections.

FIG. 2 depicts example images 202A-B before and after suppression has been performed. The images 202A-B are the same underlying image, with image 202A being shown prior to suppression being performed, and image 202B being shown after suppression being performed. The images 202A-B include multiple objects, including a truck 204. For simplicity of explanation, only the truck 204 is considered for object detection in this example. However, it should be appreciated that multiple other objects may be detected in other examples and as discussed herein.

The image 202A is shown after the preliminary bounding boxes 206, 208, 210 have been generated. More specifically, the image is processed by an object detection algorithm (e.g., a trained CNN) to generate preliminary bounding boxes, including a first preliminary bounding box 206, a second preliminary bounding box 208, and a third preliminary bounding box 210. Each of the preliminary bounding boxes 206, 208, 210 are generated for the same physical object in the image 202A (e.g., the truck 204). However, there is only one truck 204 in the image 202A. As such, the multiple preliminary bounding boxes 206, 208, 210 are duplicative of another, and some of the preliminary bounding boxes 206, 208, 210 need to be suppressed.

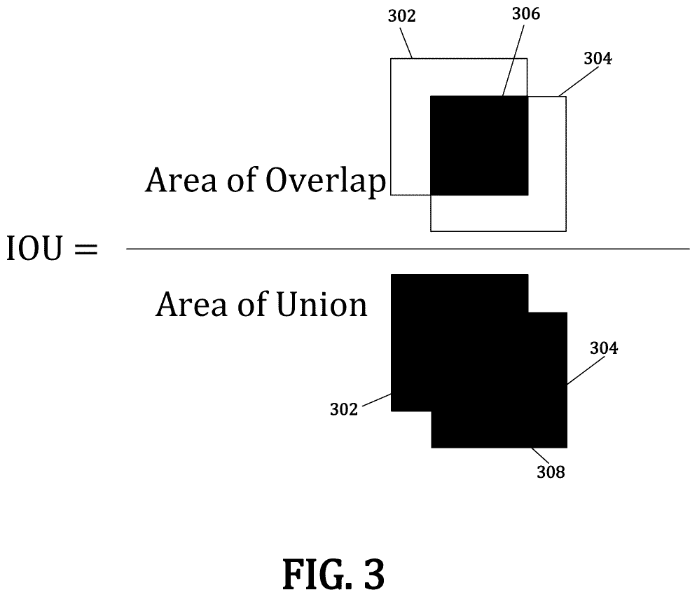

As such, a suppression algorithm is executed to suppress one or more of the duplicate preliminary bounding boxes 206, 208, 210. One example of a suppression algorithm is NMS. In NMS, an intersection-over-union (IoU) score is generated by comparing the preliminary bounding boxes 206, 208, 210 to one another. The IoU score may represent the amount of overlap between two bounding boxes. For instance, an IoU score of 0 means that there is no overlap between the two bounding boxes. An IoU score of 1 means that the two bounding boxes are completely overlapping. FIG. 3 provides an example of calculating an IoU score.

FIG. 3 depicts two example bounding boxes (a first bounding box 302 and a second bounding box 304) that are compared to generate an IoU score. To calculate an IoU score, an area of overlap 306 is calculated for the first bounding box 302 and the second bounding box 304. The area of union 308 is also calculated for the first bounding box 302 and the second bounding box 304. The area of overlap 306 is then divided by the area of union 308 to generate the IoU score.

If the IoU score exceeds a predefined threshold, the bounding box with the highest confidence score is retained and the other bounding box is discarded. As such, to perform the deduplication of preliminary bounding boxes, pairs of the preliminary bounding boxes are compared to one another, IoU scores are generated for the pairs of preliminary bounding boxes, and where the IoU scores exceed the defined threshold, preliminary bounding boxes are eliminated.

Returning to FIG. 2, the three preliminary bounding boxes 206, 208, 210 are compared to one another to generate IoU scores for each of the possible pairs of the preliminary bounding boxes 206, 208, 210. In the example depicted, based on the IoU scores exceeding a defined threshold, the first preliminary bounding box 206 and the second preliminary bounding box 208 are eliminated, and only the third preliminary bounding box 210 remains. For instance, the IoU score for the pair of the first preliminary bounding box 206 and the third preliminary bounding box 210 exceeds the threshold, and the third preliminary bounding box 210 has a higher confidence score than the first preliminary bounding box 206. Similarly, IoU score for the pair of the second preliminary bounding box 208 and the third preliminary bounding box 210 also exceeds the threshold, and the third preliminary bounding box 210 has a higher confidence score than the second preliminary bounding box 208. As such, only the third preliminary bounding box 210 is retained.

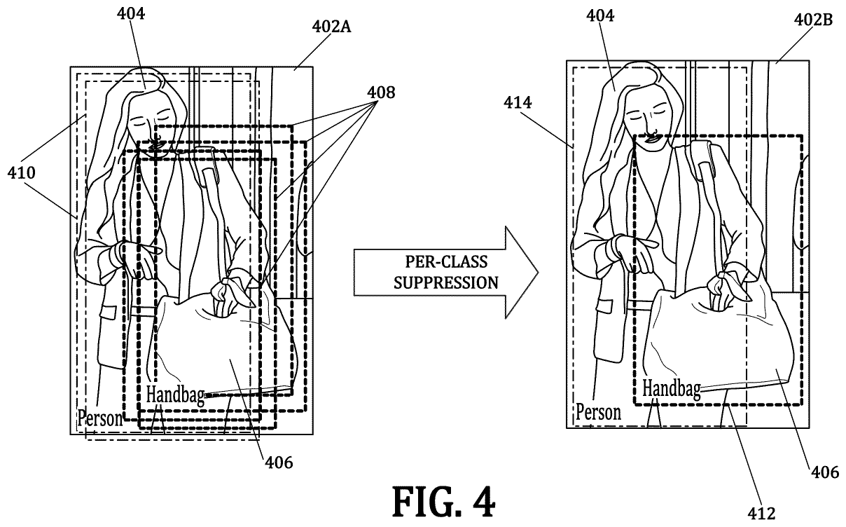

FIG. 4 depicts example images 402A-B before and after per-class suppression. The images 402A-B are the same underlying image, with image 402A being shown prior to per-class suppression being performed and image 402B being shown after per-class suppression being performed. The images 402A-B include multiple objects of different classes that are detected. In the example depicted, a person 404 is detected and a handbag 406 is detected.

In image 402A, multiple preliminary bounding boxes are generated for the person 404 and for the handbag 406. For example, first-class preliminary bounding boxes 408 are generated for the handbag 406. Each of the first-class preliminary bounding boxes 408 have a class of “handbag.” Second-class preliminary bounding boxes 410 are generated for the person 404. Each of the second-class preliminary bounding boxes 410 have a class of “person.”

A suppression process is performed separately for the first-class preliminary bounding boxes 408 and the second-class preliminary bounding boxes 410. For example, NMS may be performed for the first-class preliminary bounding boxes 408. NMS may also be performed separately for the second-class preliminary bounding boxes 410. After the NMS is performed separately against the first-class preliminary bounding boxes 408 and the second-class preliminary bounding boxes 410, a single first-class bounding box 412 (e.g., handbag bounding box) remains and a single second-class bounding box 414 (e.g., person bounding box) remains, as shown in image 402B.

In a second, class-agnostic stage of the suppression systems discussed herein, the single remaining first-class bounding box 412 (e.g., handbag bounding box) and the single remaining second-class bounding box 414 (e.g., person bounding box) may be compared to another to determine if further suppression is required. In the example depicted, no further suppression is needed. Thus, the single first-class bounding box 412 and the single second-class bounding box 414 for the final or filtered set of bounding boxes.

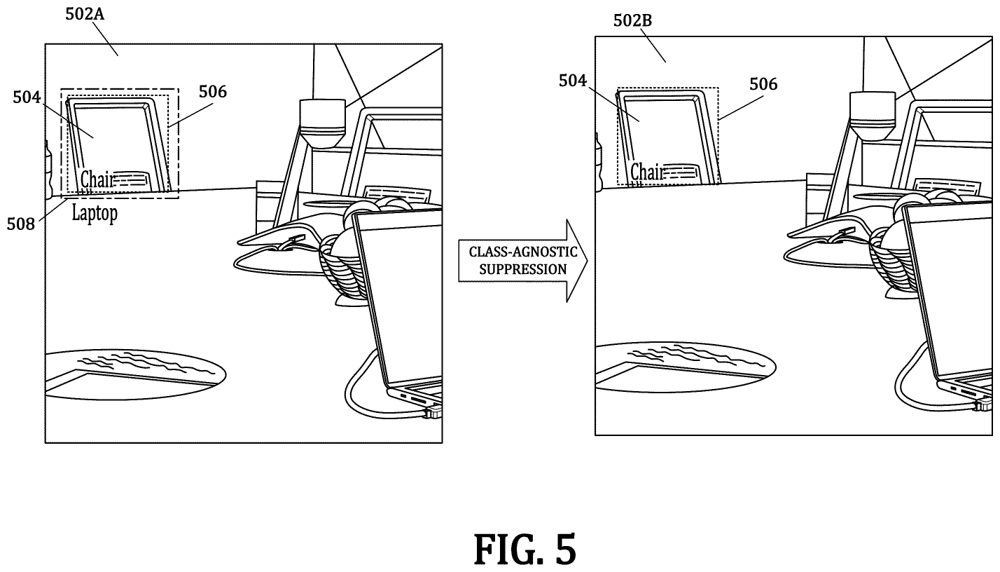

FIG. 5 depicts example images 502A-B before and after class-agnostic suppression. The images 502A-B are the same underlying image, with image 502A being shown prior to per-class suppression being performed and image 502B being shown after per-class suppression being performed.

The images 502A-B include a chair 504 that has been detected by the object detection algorithm to be both a chair and a laptop. For instance, bounding boxes have been generated for the chair 504 that have a class of chair and a class of laptop. Multiple preliminary bounding boxes may have been generated for each of the chair class and the laptop class, and the per-class suppression may have already been performed. As a result of the per-class suppression, a first-class bounding box 506 (e.g., a chair bounding box 506) and a second-class bounding box 508 (e.g., a laptop bounding box 508) remain, as shown in image 502A.

The class-agnostic suppression is then performed for the chair bounding box 506 and the laptop bounding box 508. For instance, an NMS process may be performed by comparing the chair bounding box 506 and the laptop bounding box 508 to determine an IoU score. The IoU score is compared to a threshold. In some examples, the IoU threshold for the class-agnostic NMS process is higher than the IoU threshold for the per-class NMS process. By using a higher IoU threshold, the class-agnostic suppression process helps ensure that the bounding boxes are suppressed only when the two bounding boxes are essentially the same bounding boxes over the same space (e.g., the bounding boxes are positioned in substantially the same region and have substantially the same size). Accordingly, where two different objects are in fact overlapping, their respective bounding boxes are properly maintained.

In the example depicted, the IoU score for the chair bounding box 506 and the laptop bounding box 508 exceeds the IoU threshold. The chair bounding box 506 has a higher confidence score than the laptop bounding box 508. As a result, the chair bounding box 506 is retained, and the laptop bounding box 508 is discarded. Thus, the post-suppression image 502B includes only the chair bounding box 506, which accurately classifies the region of the chair 504 and the class of the chair 504.

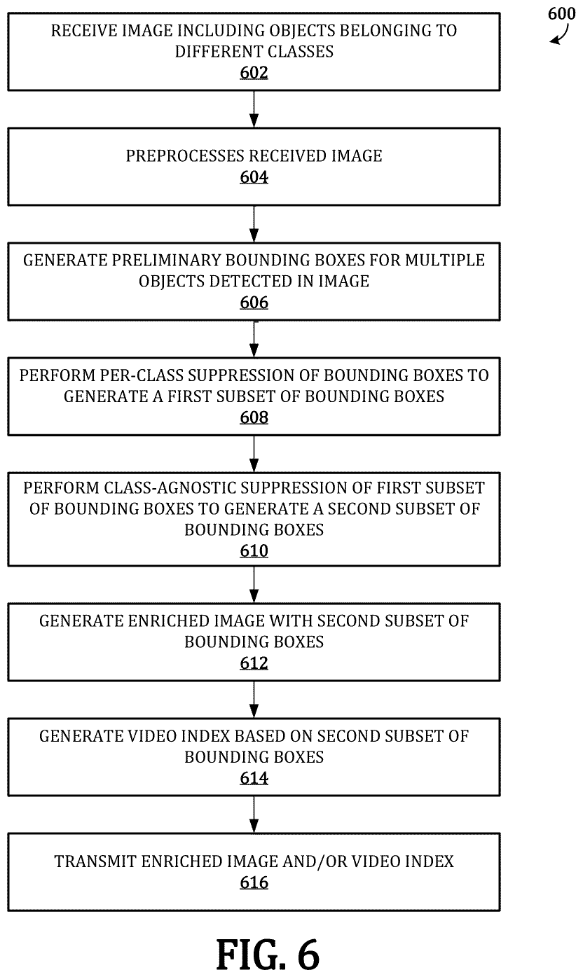

FIG. 6 depicts an example method 600 for performing two-stage suppression of bounding boxes. The method 600 may be performed by the systems described herein and/or the components of such systems. For example, the method 600 may be performed by the image processing system 104 and/or the components thereof.

At operation 602, an image is received that includes (e.g., depicts) multiple objects belonging to different classes. The image may be received from a separate device and/or the image may be received by accessing the image and/or video locally on the device that is performing the method 600. For example, the image may include a first-class object belonging to a first class and a second-class object belonging to a second class. In some examples, the objects are blocking, overlapping, and/or occluding one another. For instance, the first-class object may be at least partially occluding, blocking, or overlapping with in the second-class object (or vice versa). The image may be part of video data, such as a frame from the video data. In other examples, the image is a standalone image that is not part of video data.

At operation 604, the received image may be preprocessed. For instance, the color formatting and/or aspect ratio of the image may be altered. Other changes or alterations may be made based on the requirements of the object model being used. As an example, if the object detection model was trained with a particular image format, the received image is adjusted to match that training format.

At operation 606, preliminary bounding boxes for multiple objects detected in the image are generated. In examples, the generation of the preliminary bounding boxes is performed as part of the object detection process that is performed on the image. The object detection may rely on various different models, techniques, algorithms, and/or processes that detect objects and their classes within an image. Some example object detection techniques include the use of a neural network, such as a convolutional neural network (CNN). For instance, an R-CNN (Regions with CNN Features) may be implemented. R-CNN may also be implemented with a Region Proposal Network, such as in the Faster R-CNN algorithm. Other types of object-detection techniques or models are also possible and may be implemented herein.

At operation 608, a per-class suppression of the preliminary bounding boxes is performed to select a first subset of bounding boxes. The per-class suppression removes duplicate bounding boxes from each of the classes. Accordingly, the per-class suppression provides better separation between the classes. The per-class suppression may be an NMS process that separately analyzes groups of preliminary bounding boxes that have been grouped by class. Additional details of pre-class suppression are provided above and also below with respect to FIG. 7. The remaining bounding boxes that are not eliminated by the per-class suppression form the first subset of bounding boxes.

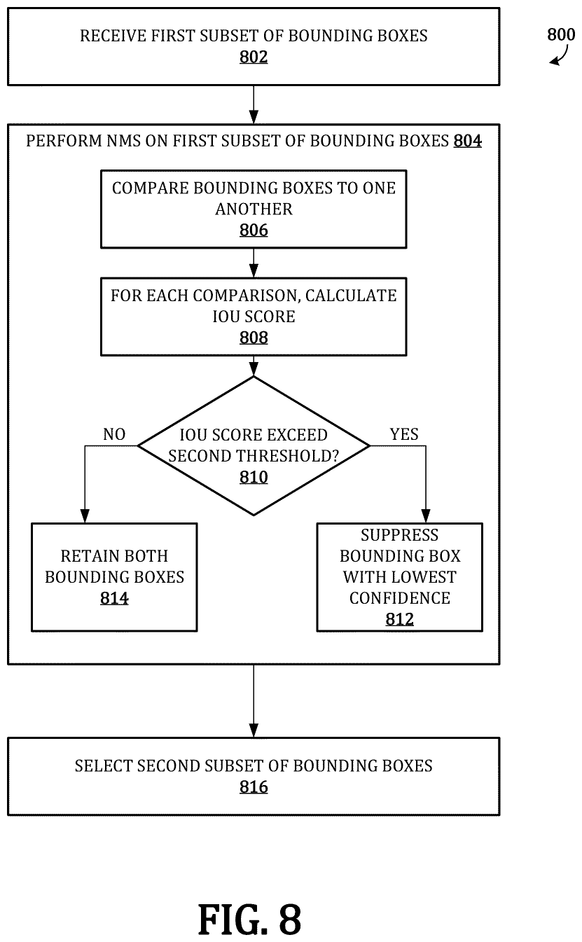

At operation 610, class-agnostic suppression is performed on the first subset of bounding boxes that resulted from the per-class suppression in operation 608. The class-agnostic suppression process removes duplicate bounding boxes across all remaining classes in the first set of bounding boxes. Accordingly, the class-agnostic suppression is able to resolve object-class ambiguities. The class-agnostic suppression may be an NMS process that analyzes all the bounding boxes in the first subset of bounding boxes regardless of class. In other words, the class-agnostic suppression does not consider or utilize the classes of the bounding boxes. Additional details of the class agnostic suppression are provided above and also below with respect to FIG. 8. The remaining bounding boxes that are not eliminated by the class-agnostic suppression form a second subset of bounding boxes. The second subset of bounding boxes may be considered the filtered or final bounding boxes.

At operation 612, an enriched image is generated from the image received in operation 602 and the filtered bounding boxes generated in operation 610. The enriched image may be the original image with the final bounding boxes overlaid or otherwise displayed on the image.

In some examples, where the image is from video data and represents a frame from the video data, the operations 602-612 are repeated for different frames of the video feed. For example, the operations 602-612 may be repeated for each frame (or for every N frames) of the video data. Filtered bounding boxes are thus generated for multiple frames of the video data. In such examples, at operation 614, a video index may be generated from the filtered bounding boxes from the respective frames of the video data.

At operation 616, the enriched image and/or the video index are transmitted. In an example, the enriched image and/or the video index are transmitted to a client device for display and/or further processing. Additionally or alternatively, the enriched image and/or the video index are transmitted to a storage device for later processing or access.

While a two-stage suppression process initially seems less efficient than a single-stage general NMS process, the two-stage suppression process described herein can actually be more computationally efficient than a general NMS process. For example, for n bounding boxes, the general NMS complexity is on the order of O(n²). The per-class NMS of the two-stage process disclosed herein still has the same quadratic complexity, but with a smaller n (e.g., number of bounding boxes) for each group, which reduces the average complexity. Following the per-class NMS stage, there are significantly fewer bounding boxes remaining. Thus, the second, class-agnostic NMS is applied to a much smaller input. This means that for an image that contains multiple classes, the two-stage suppression discussed herein runs faster and provides better quality than a general, single-step NMS process.

FIG. 7 depicts an example method 700 for performing per-class suppression of bounding boxes. The method 700 may be performed by the systems described herein and/or the components of such systems. For example, the method 700 may be performed by the image processing system 104 and/or the components thereof. Example method 700 may be performed as part of operation 608 in method 600.

At operation 702, the preliminary bounding boxes are grouped by class to create groups for preliminary bounding boxes. In an example, there is a first-class group of bounding boxes corresponding to a first class and a second-class group of bounding boxes corresponding to a second class.

At operation 704, NMS is separately performed on each group of bounding boxes. For example, operations 706-714 are performed for each group of bounding boxes.

At operation 706, bounding boxes within a particular group are compared to one another. At operation 708, for each of the comparisons (e.g., for each pair of bounding boxes) an IoU score is calculated. Operations 710-714 are then performed for each of the comparisons (e.g., for each pair).

At operation 710, the IoU score is compared to a first threshold. The first threshold may be referred to herein as a per-class threshold or a per-class IoU threshold. In some examples, the per-class threshold is less than 0.5, such as between 0.1-0.5, 0.2-0.5, 0.3-0.5, or 0.3-0.45.

If the IoU score for the pair exceeds the per-class threshold, the method 700 flows to operation 712 where the bounding box (of the pair) with the lower confidence score is suppressed or eliminated. The bounding box (of the pair) with the higher confidence score is thus retained and included in a first subset of bounding boxes. If the IoU score for the pair does not exceed the per-class threshold, the method 700 flows to operation 714 where both of the bounding boxes of the pair are retained in the first subset of bounding boxes. Even if a bounding box is retained from an analysis in one pair, that bounding box may be ultimately eliminated based on a comparison to another bounding box. Ultimately, the NMS process of operation 704 removes duplicate bounding boxes for each class.

At operation 716, the first subset of bounding boxes is selected. The first subset of bounding boxes includes the bounding boxes from each group that were not eliminated as part of the NMS process performed in operation 704.

FIG. 8 depicts an example method 800 for performing class-agnostic suppression of bounding boxes. The method 800 may be performed by the systems described herein and/or the components of such systems. For example, the method 800 may be performed by the image processing system 104 and/or the components thereof. Example method 800 may be performed as part of operation 610 in method 600.

At operation 802, the first subset of bounding boxes is received. The first subset of bounding boxes is the first subset of bounding boxes selected by the per-class suppression, such as the first subset of bounding boxes selected in operation 716 of method 700.

At operation 804, NMS is performed on the first subset of bounding boxes. The NMS is performed across all the bounding boxes in the first subset without regard to class. For instance, a bounding box of a first class may be compared to a bounding box of a second class.

At operation 806, the bounding boxes within the first subset are compared to one another. At operation 808, for each of the comparisons (e.g., for each pair of bounding boxes) an IoU score is calculated. Operations 810-814 are then performed for each of the comparisons (e.g., for each pair).

At operation 810, the IoU score is compared to a second threshold. The second threshold may be referred to herein as a class-agnostic threshold or a class-agnostic IoU threshold. The class-agnostic threshold may be greater than the per-class threshold. In some examples, the class-agnostic threshold is greater than 0.5, such as between 0.5-0.95, 0.7-0.95, 0.8-0.95, greater than 0.8, greater than 0.85, and/or greater than 0.9. In some examples, the class-agnostic threshold is at least double the per-class threshold. As discussed above, having the class-agnostic threshold be greater than the per-class threshold protects against suppressing bounding boxes of different classes when the bounding boxes do in fact correspond to two different objects.

If the IoU score for the pair exceeds the class-agnostic threshold, the method 800 flows to operation 812 where the bounding box (of the pair) with the lower confidence score is suppressed or eliminated. The bounding box (of the pair) with the higher confidence score is thus retained, and included in a second subset of bounding boxes. If the IoU score for the pair does not exceed the class-agnostic threshold, the method 800 flows to operation 814 where both of the bounding boxes of the pair are retained in the second subset of bounding boxes. Even if a bounding box is retained from an analysis in one pair, that bounding box may be ultimately eliminated based on a comparison to another bounding box. Ultimately, the NMS process of operation 804 removes duplicate bounding boxes, regardless of class, from the first subset of bounding boxes.

At operation 816, the second subset of bounding boxes is selected. The second subset of bounding boxes includes the bounding boxes that were not eliminated as part of the NMS process performed in operation 804. As such, the second subset of bounding boxes contains less than or equal the number of bounding boxes in the first subset of bounding boxes. The second subset of bounding boxes may be referred to herein as the final or filtered set of bounding boxes.

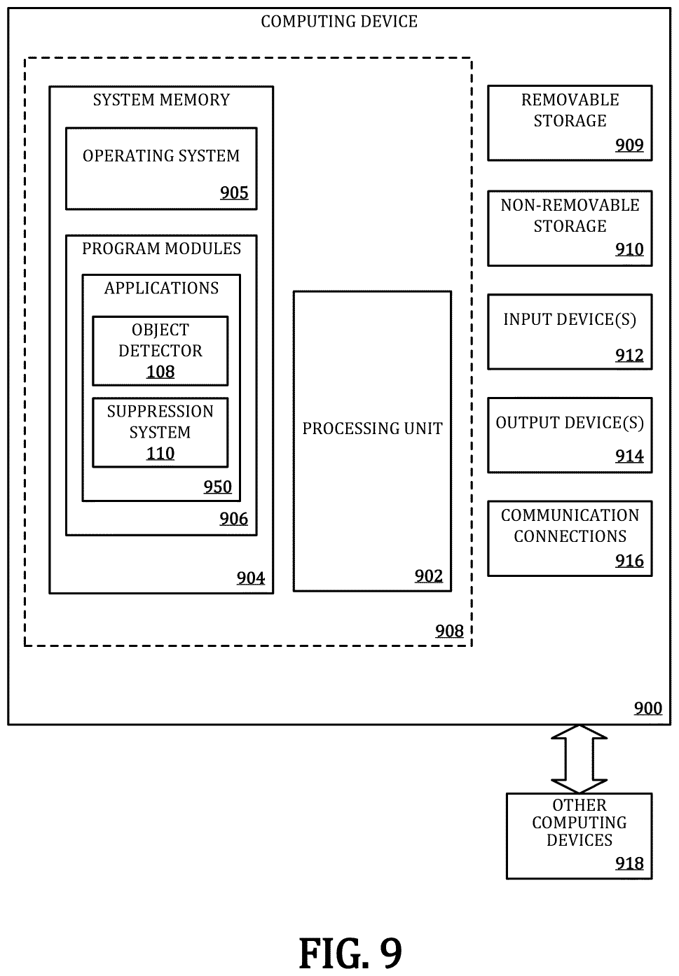

FIG. 9 is a block diagram illustrating physical components (e.g., hardware) of a computing device 900 with which examples of the present disclosure may be practiced. The computing device components described below may be suitable for one or more of the components of the systems described above. In a basic configuration, the computing device 900 includes at least one processing system or unit 902 and a system memory 904. The processing system 902 may include one or more processors that are configured to execute instructions stored by the system memory 904. Depending on the configuration and type of computing device 900, the system memory 904 comprises volatile storage (e.g., random access memory), non-volatile storage (e.g., read-only memory), flash memory, or any combination of such memories. The system memory 904 may include an operating system 905 and one or more program modules 906 suitable for running software applications 950 (e.g., object detector 108 and/or suppression system 110) and other applications.

The operating system 905 is suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. In an example, the computing device 900 includes additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing system 902, the program modules 906 may perform processes including one or more of the stages of the methods 600, 700, and 800, illustrated in FIG. 6-8. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 900 on the single integrated circuit (chip). Examples of the present disclosure may also be practiced using other technologies capable of performing logical operations such as, for example, AND, OR, and NOT, including mechanical, optical, fluidic, and quantum technologies.

In examples, the computing device 900 also has one or more input device(s) 912 such as a keyboard, a mouse, a pen, a sound input device, a touch input device, a camera, etc. The output device(s) 914 such as a display, speakers, a printer, etc. may also be included. The aforementioned devices are examples and others may be used. The computing device 900 may include one or more communication connections 916 allowing communications with other computing devices 918. Examples of suitable communication connections 916 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 904, the removable storage device 909, and the non-removable storage device 910 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer readable media may be part of the computing device 900. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system for performing two-stage suppression of bounding boxes, the system comprising:
a processing system comprising at least one processor; and
memory storing instructions that, when executed by the processing system, cause the system to perform operations comprising:
receive an image depicting multiple objects belonging to different classes;
generate preliminary bounding boxes for the multiple objects, wherein each of the preliminary bounding boxes comprises a size, a location, a class, and a confidence score;
select a first subset of bounding boxes by performing a per-class suppression of the preliminary bounding boxes;
select a second subset of bounding boxes by performing a class-agnostic suppression of the first subset of bounding boxes; and
based on the second subset of bounding boxes, generate at least one of an enriched image or a video index.

2. The system of claim 1, wherein performing the per-class suppression comprises:
grouping the preliminary bounding boxes by class; and
separately performing Non-Maximum Suppression (NMS) on each of the groups of preliminary bounding boxes.

3. The system of claim 2, wherein performing the class-agnostic suppression comprises performing NMS on the first subset of bounding boxes without regard to class.

4. The system of claim 3, wherein:
the per-class suppression utilizes a per-class intersection-over-union (IoU) threshold;
the class-agnostic suppression utilizes a class-agnostic IoU threshold; and
the class-agnostic IoU threshold is greater than the per-class IoU threshold.

5. The system of claim 4, wherein the class-agnostic IoU threshold is at least twice the per-class IoU threshold.

6. The system of claim 4, wherein the class-agnostic IoU threshold is greater than 0.8, and the per-class IoU threshold is within a range of 0.3-0.45.

7. The system of claim 1, wherein the image is part of video data, and the operations comprise generating the video index.

8. A computer-implemented method for performing two-stage suppression of bounding boxes, the method comprising:
receiving an image depicting a first object having a first class and a second object having a second class;
generating preliminary bounding boxes for the first object and the second object;
grouping the preliminary bounding boxes into a first group of preliminary bounding boxes having the first class and a second group of preliminary bounding boxes having the second class;
selecting a first subset of bounding boxes by separately performing NMS on the first group of preliminary bounding boxes and the second group of preliminary bounding boxes to deduplicate bounding boxes from the first group and the second group; and
selecting a second subset of bounding boxes by performing NMS on the first subset of bounding boxes, without regard to class.

9. The computer-implemented method of claim 8, further comprising, based on the second subset of bounding boxes, generating at least one of an enriched image or a video index.

10. The computer-implemented method of claim 8, wherein the first object at least partially occludes the second object in the image.

11. The computer-implemented method of claim 10, wherein the second subset of bounding boxes includes a single bounding box for the first object and a single bounding box for the second object.

12. The computer-implemented method of claim 8, wherein:
performing the NMS on the first group and the second group utilizes a per-class IoU threshold;
performing NMS on the first subset of bounding boxes utilizes a class-agnostic IoU threshold; and
the class-agnostic IoU threshold is greater than the per-class IoU threshold.

13. The computer-implemented method of claim 12, wherein the class-agnostic IoU threshold is greater than 0.5, and the per-class IoU threshold is less than 0.5.

14. The computer-implemented method of claim 8, wherein the image is part of video data, and the method further comprises generating a video index based on the second subset of bounding boxes.

15. A computer-implemented method for performing two-stage suppression of bounding boxes, the method comprising:
receiving an image depicting multiple objects belonging to different classes;
generating preliminary bounding boxes an image depicting multiple objects, wherein each of the preliminary bounding boxes comprises a size, location, class, and confidence score;
performing a per-class NMS of the preliminary bounding boxes to select a subset of bounding boxes;
performing a class-agnostic NMS of the subset of bounding boxes to select a set of filtered of bounding boxes; and
based on the set of filtered bounding boxes, generating at least one of an enriched image or a video index.

16. The computer-implemented method of claim 15, wherein performing the per-class NMS comprises:
grouping the preliminary bounding boxes by class;
for each group of preliminary bounding boxes:
comparing bounding boxes within the group to calculate an IoU score for each compared pair of bounding boxes; and
for pairs of bounding boxes having an IoU score exceeding a per-class IoU threshold, eliminating the bounding box of the pair with the lower confidence score.

17. The computer-implemented method of claim 16, wherein the per-class IoU threshold is within a range of 0.3-0.45.

18. The computer-implemented method of claim 15, wherein performing the class-agnostic NMS comprises:
comparing bounding boxes within the subset of bounding boxes to calculate an IoU score for each compared pair of bounding boxes; and
for pairs of bounding boxes having an IoU score exceeding a class-agnostic IoU threshold, eliminating the bounding box of the pair with the lower confidence score.

19. The computer-implemented method of claim 18, wherein the class-agnostic IoU threshold is at least 0.8.

20. The computer-implemented method of claim 15, wherein the multiple objects include a first object of a first class and a second object of a second class, wherein the second object at least partially occludes the first object.
